(19) United States
(12) Patent Application Publication
(10) Pub. No.: US 2005/0066695 A1
(43) Pub. Date: Mar. 31, 2005

(54) Single action handle mechanism for operating the door/window

(76) Inventor: Rajan Bajaj, Aligarh (IN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/488,336

(22) PCT Filed: Aug. 28, 2002
(86) PCT No.: PCT/IN02/00174

(30) Foreign Application Priority Data
Aug. 30, 2001 (IN) 896/DEL/2001

(51) Int. Cl. E05B 13/00

(52) U.S. Cl. 70/210

(57) ABSTRACT

This invention provides a single action handle mechanisms for operating the door/window comprising at least two handles connected to a cam, which operates the spring loaded latch characterized in that said handles are mounted on two handle plates, each handle functioning independently of the other, the said handle plates are connected to two inner operating plates, and at least one pin fixed to each of said inner plates such that when any of said handles is pushed or pulled, the cam operates the latch inwardly to open the door/window.

### FIELD OF THE INVENTION

This invention relates to a single action handle mechanism for operating the door/window.

### BACKGROUND OF THE INVENTION

The conventional door/window handles operate on the double action mechanism for operating the door or window. The conventional door/window handle mechanism is shown in FIGS. 1a, 1b & 1c of the accompanying drawings. It consists of handles (1A, 1B), which are interconnected with a connecting rod (2) such that when handle (1A) moves, the handle (1B) also moves. The said handles are connected to a cam (1), which operates the spring loaded latch (L). On rotating the handle, (1A or 1B) downward to the extent of about 45°, it retracts the is latch (L) from door frame against the compression spring (3). On releasing the handles (1A, 1B), latch (L) comes out due to said spring pressure on latch (L). To open the door or window, two actions are required, viz., firstly the handle has to be rotated downwardly for about 45°, and secondly a simultaneous push or pull is required to open the door/window.

The drawback of the conventional door/window handle mechanism is that the handle(s) mounted in front and back of the door are connected by a connecting rod (2) resulting in more wear and tear of handle assembly. Furthermore, a single handle can not be used in case of a window.

### THE OBJECTS AND SUMMARY OF THE INVENTION

The object of this invention is to obviate the aforesaid drawback.

Further object of this invention is to provide a single action handle mechanism.

Yet another object of this invention is to provide handles functioning independently of each other.

To achieve the said objectives this invention provides a single action handle mechanism for operating the door/window comprising at least two handles connected to a cam which operates the spring loaded latch characterized in that:
said handle(s) is mounted on one or more handle plates, each handle functioning independently of the other,
said handle plates are connected to one or more inner operating plates, and
at least one pin fixed to each of said inner plates such that when any of said handles is pushed or pulled, the cam operates the latch inwardly to open the door/window.

A separate lock is provided in said mechanism to lock the door.

One handle is used for operating the window.

Two handles are used for operating the door.

A spring is provided with the latch to operate the door in single action.

The said handles can be of any desired shape.

### BRIEF DESCRIPTION OF THE DRAWINGS

The invention will now be described with reference to the accompanying drawings:

FIGS. 1a, 1b & 1c show the conventional door/window handle mechanism for operating the door/window.

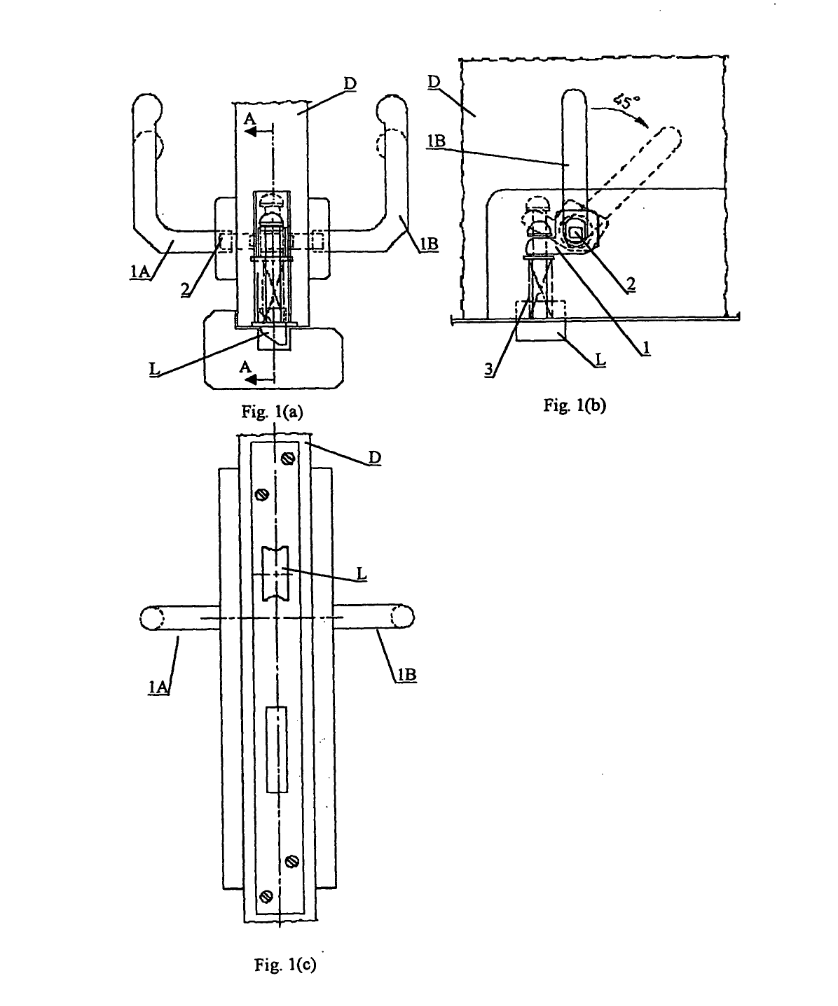

FIGS. 2a, 2b, 2c show the single action handle mechanism for operating the door/window, according to this invention.

FIGS. 3a, 3b & 3c shows the type of handles for a single action handle mechanism for operating the door/window, according to this invention.

### DETAILED DESCRIPTION

The conventional door/window handle mechanism has been described under the heading ‘background’.

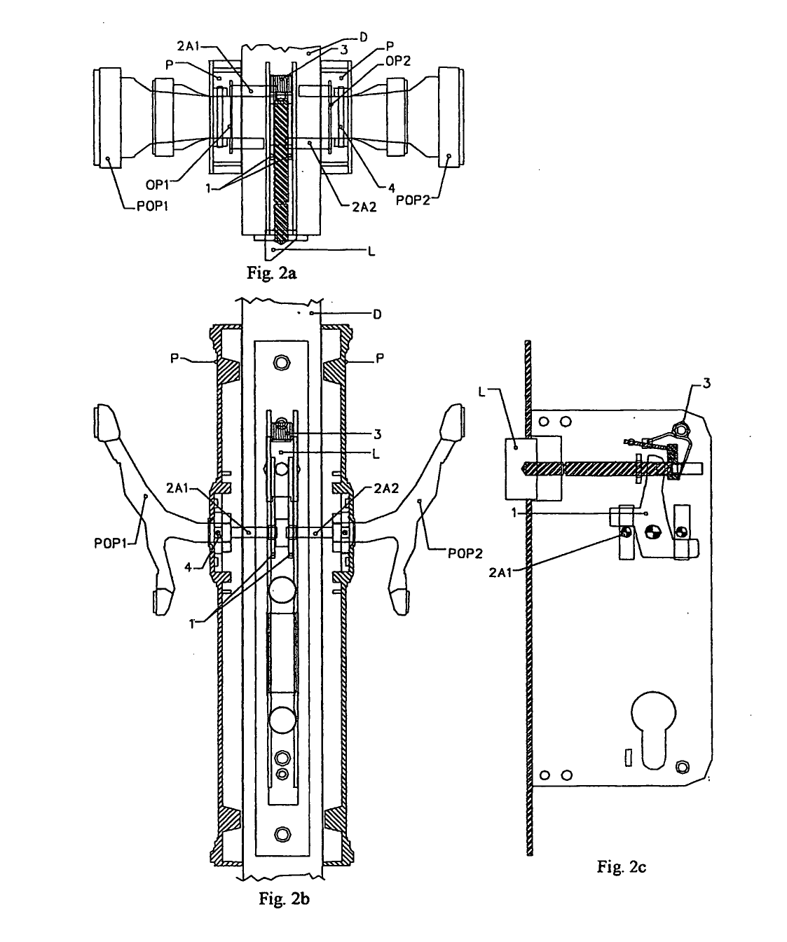

FIGS. 2a, 2b & 2c describe a single action door/window handle mechanism. According to this invention, the handles (POP1, POP2) are fitted to the operating plates (OP1, OP2) and are provided for push/pull action simultaneously. The said handles operate independently of each other. Pins (2A1, 2A2) are attached to the other side of the operating plate. On pushing/pulling the handle (OP1 or POP2), pins (2A1, 2A2) attached to the operating plates (OP1, OP2), swings the cam (1), which retracts the latch (L) against the spring (3), which in turn releases the door in a single action. On releasing the handle (POP1 or POP2), the latch (L) comes forward due to the spring force. In case of a window either of the handle (POP1 or POP2) can be used individually.

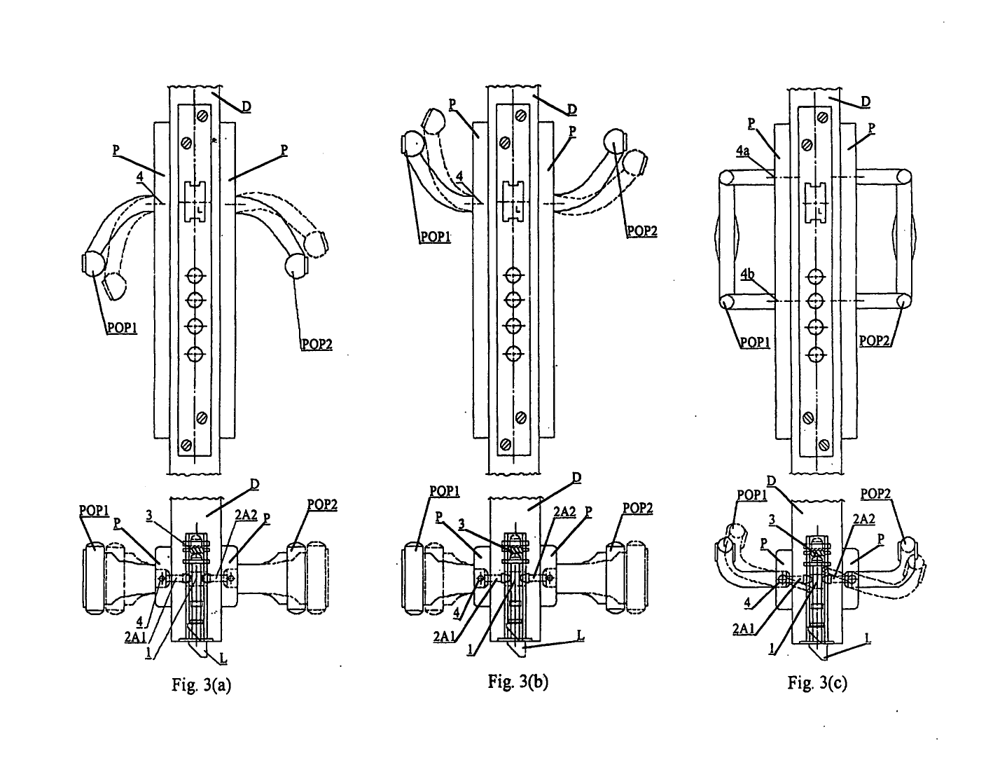

Handles (POP1, POP2) can be of different designs and can be connected to two pivots (4a & 4b) or at a single point (4), as shown in FIGS. 3a, 3b & 3c.

Further, the position of handles can be changed around 360° in one plane without any basic change of operating mechanism, to create different models of door/window operating mechanism to suit the customers. This mechanism has application for hotels, restaurants and office buildings and is convenient for operation.

1. A single action handle mechanism for operating the door/window comprising at least two handles connected to a cam which operates the spring loaded latch characterized in that:
said handle(s) is mounted on one or more handle plates, each handle functioning independently of the other,
said handle plates are connected to one or more inner operating plates, and
at least one pin fixed to each of said inner plates such that when any of said handles is pushed or pulled, said pin(s) swings to rotate the cam, which operates the latch inwardly to open the door/window.

2. A single action handle mechanism as claimed in claim 1 wherein a separate lock is provided in said mechanism to lock the door.

3. A single action handle mechanism as claimed in claim 1 wherein one handle is used for operating the window.

4. A single action handle mechanism as claimed in claim 1 wherein two handles are used for operating the door.

5. A single action handle mechanism as claimed in claim 1 wherein a spring is provided with the latch to operate the door in single action.

6. A single action handle mechanism as claimed in claim 1 wherein said handles can be of any desired shape.
